(19) United States
(12) Patent Application Publication
(10) Pub. No.: US 2018/0130467 A1
(43) Pub. Date: May 10, 2018

(54) IN-VEHICLE SPEECH RECOGNITION DEVICE AND IN-VEHICLE EQUIPMENT

(71) Applicant: MITSUBISHI ELECTRIC CORPORATION, Tokyo (JP)

(72) Inventor: Takayoshi CHIKURI, Tokyo (JP)

(73) Assignee: MITSUBISHI ELECTRIC CORPORATION, Tokyo (JP)

(21) Appl. No.: 15/576,648

(22) PCT Filed: Sep. 9, 2015
(86) PCT No.: PCT/JP2015/075595

§ 371 Date: Nov. 22, 2017

(51) Int. Cl. G10L 15/22; G10L 25/78

(52) U.S. Cl. CPC G10L 15/22; G10L 2015/223; G10L 2015/221; G10L 25/78

(57) ABSTRACT

A speech recognition unit recognizes speech within a preset period. A determination unit determines whether the number of utterers in a vehicle is singular or plural. A recognition control unit adopts a recognition result relating to speech uttered after receiving an indication that an utterance is about to start when the number of utterers is plural, and when the number of utterers is singular, adopts a recognition result regardless of whether the recognition result relates to speech uttered after the indication is received or the recognition result relates to speech uttered in a case where the indication is not received. A control unit performs an operation corresponding to the recognition result adopted by the recognition control unit.

### TECHNICAL FIELD

The invention relates to an in-vehicle speech recognition device for recognizing an utterance given by an utterer, and in-vehicle equipment that operates in response to a recognition result.

### BACKGROUND ART

When a plurality of utterers are present in a vehicle, it is necessary to avoid that a speech recognition device erroneously recognizes an utterance given by a certain utterer to another utterer as an utterance given to the device. For this purpose, a speech recognition device disclosed in Patent Literature 1, for example, waits for a user to utter a specific utterance or perform a specific operation, and starts to recognize a command for operating equipment to be operated after detecting the specific utterance or the like.

### CITATION LIST

### Patent Literature

Patent Literature 1: Japanese Patent Application Publication No. 2013-80015

### SUMMARY OF INVENTION

### Technical Problem

With the conventional speech recognition device, a situation in which the speech recognition device recognizes an utterance as a command, contrary to the intentions of the utterer, can be avoided, and as a result, it is possible to prevent an erroneous operation of the equipment to be operated. Further, during a one-to-many dialog between people, it is natural for the utterer to speak after specifying an addressee by addressing him/her by name or the like, so that a natural dialog between the utterer and the device can be achieved by uttering a command after utterance of a specific utterance or the like, such as addressing remarks to the speech recognition device.

In the speech recognition device described in Patent Literature 1, however, the utterer feels it troublesome to utter the specific utterance or the like before uttering a command even in a situation where the driver is the only utterer in a space inside the vehicle, and it is obvious that an utterance is a command intended for the device. Moreover, in this situation, the dialog with the speech recognition device resembles a one-to-one dialog with a person, and therefore there is a problem in that the utterer finds it awkward to utter the specific utterance or the like in order to address the speech recognition.

In other words, in the conventional speech recognition device, the utterer needs to utter the specific utterance or perform the specific operation in relation to the speech recognition device regardless of the number of people in the vehicle, and as a result, there is a problem of operability in that the utterer feels the dialog awkward and troublesome.

The invention has been designed to solve the problems described above, and an object thereof is to prevent erroneous recognition while improving operability.

### Solution to Problem

An in-vehicle speech recognition device according to the invention includes a speech recognition unit for recognizing speech and outputting a recognition result, a determination unit for determining whether the number of utterers in a vehicle is singular or plural, and outputting a determination result, and a recognition control unit for, on a basis of the results output by the speech recognition unit and the determination unit, adopting a recognition result relating to speech uttered after an indication that an utterance is about to start is received when the number of utterers is determined to be plural, and when the number of utterers is determined to be singular, adopting a recognition result regardless of whether the recognition result relates to speech uttered after an indication that an utterance is about to start is received, or the recognition result relates to speech uttered in a case where the indication that an utterance is about to start is not received.

### Advantageous Effects of Invention

According to the invention, the recognition result relating to the speech uttered after receiving the indication that an utterance is about to start is adopted when a plurality of utterers are present in the vehicle, and therefore a situation in which an utterance given by a certain utterer to another utterer is recognized erroneously as a command can be avoided. In contrast, when only one utterer is present in the vehicle, regardless of whether the recognition result relates to the speech uttered after receiving the indication that an utterance is about to start or the recognition result relates to speech uttered in a case where the indication that an utterance is about to start is not received, the recognition result is adopted, and therefore the utterer does not need to issue an indication that an utterance is about to start before uttering a command. As a result, awkward and troublesome dialog can be eliminated, enabling an improvement in operability.

### BRIEF DESCRIPTION OF DRAWINGS

FIG. 1 is a block diagram showing an example configuration of in-vehicle equipment according to Embodiment 1 of the invention.

FIG. 2 is a flowchart showing processing executed by the in-vehicle equipment according to Embodiment 1 to switch recognized vocabulary of a speech recognition unit in accordance with whether the number of utterers in a vehicle is singular or plural.

FIG. 3 is a flowchart showing processing executed by the in-vehicle equipment according to Embodiment 1 to recognize speech uttered by an utterer and perform an operation corresponding to a recognition result.

FIG. 4 is a block diagram showing an example configuration of in-vehicle equipment according to Embodiment 2 of the invention.

FIGS. 5A and 5B are flowcharts showing processing executed by the in-vehicle equipment according to Embodiment 2, wherein FIG. 5A shows processing executed when the number of utterers in the vehicle is determined to be plural, and FIG. 5B shows processing executed when the number of utterers in the vehicle is determined to be singular.

FIG. 6 is a view showing a configuration of main hardware of the in-vehicle equipment and peripheral equipment thereof, according to the respective embodiments of the invention.

### DESCRIPTION OF EMBODIMENTS

Embodiments of the invention will be described in detail below with reference to attached drawings.

### Embodiment 1

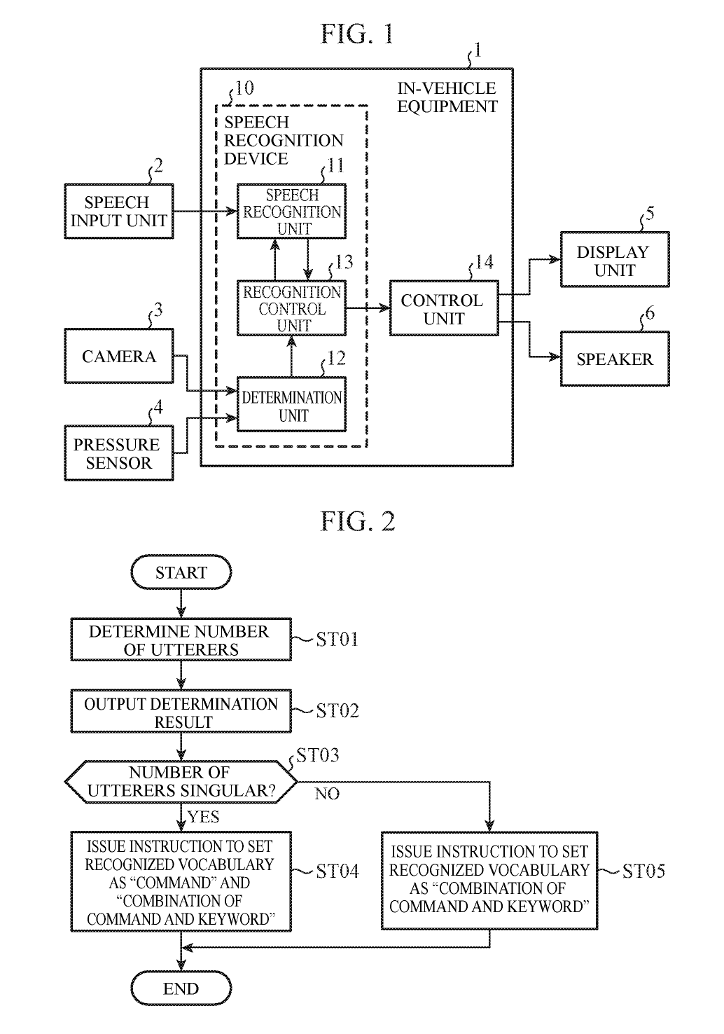

FIG. 1 is a block diagram showing an example of the configuration of in-vehicle equipment 1 according to Embodiment 1 of the invention. The in-vehicle equipment 1 includes a speech recognition unit 11, a determination unit 12, a recognition control unit 13, and a control unit 14. The speech recognition unit 11, the determination unit 12, and the recognition control unit 13 constitute a speech recognition device 10. Further, a speech input unit 2, a camera 3, a pressure sensor 4, a display unit 5, and a speaker 6 are connected to the in-vehicle equipment 1.

In the example shown in FIG. 1, the speech recognition device 10 is incorporated into the in-vehicle equipment 1, but the speech recognition device 10 may be configured independently of the in-vehicle equipment 1.

When the number of utterers in the vehicle is plural, the in-vehicle equipment 1 operates, on the basis of output from the speech recognition device 10, in accordance with the content of an utterance after receiving a specific indication from the utterer. In contrast, when the number of utterers in the vehicle is singular, the in-vehicle equipment 1 operates in accordance with the content of an utterance given by the utterer regardless of presence or absence of the indication.

The in-vehicle equipment 1 is equipment installed in a vehicle, such as a navigation device or an audio device, for example.

The display unit 5 is an LCD (Liquid Crystal Display), an organic EL (Electroluminescence) display, or the like, for example. Further, the display unit 5 may be a display-integrated touch panel formed from an LCD or organic EL display and a touch sensor, or may be a head-up display.

The speech input unit 2 receives speech uttered by the utterer, implements A/D (Analog/Digital) conversion on the speech by means of PCM (Pulse Code Modulation), for example, and inputs the converted speech into the speech recognition device 10.

The speech recognition unit 11 includes “a command for operating the in-vehicle equipment” (hereafter referred to as “a command”) and “a combination of keyword and command” as recognized vocabulary, and switches the recognized vocabulary on the basis of an instruction from the recognition control unit 13, which is described below. “A command” includes recognized vocabulary such as “Set a destination”, “Search for a facility”, and “Radio”, for example.

The “keyword” is provided to clarify to the speech recognition device 10 that a command is about to be uttered by the utterer. In Embodiment 1, utterance of the keyword by the utterer corresponds to the aforesaid “specific indication from the utterer”. The “keyword” may be set in advance when the speech recognition device 10 is designed, or may be set in the speech recognition device 10 by the utterer. For example, when “Mitsubishi” is set as “keyword”, “combination of keyword and command” would be “Mitsubishi, set a destination”.

Note that the speech recognition unit 11 may recognize other ways of saying respective commands. For example, “Please set a destination”, “I want to set a destination”, and so on may be recognized as other ways of saying “Set a destination”.

The speech recognition unit 11 receives digitized speech data from the speech input unit 2. The speech recognition unit 11 then detects a speech zone (hereafter referred to as an “utterance zone”) corresponding to the content uttered by the utterer from the speech data. Subsequently, a characteristic amount of the speech data in the utterance zone is extracted. The speech recognition unit 11 then implements recognition processing for the characteristic amount using the recognized vocabulary instructed by the recognition control unit 13, which is described below, as a recognition target, and outputs a recognition result to the recognition control unit 13. A typical method such as an HMM (Hidden Markov Model) method, for example, may be used as a recognition processing method, and therefore its detailed description will be omitted.

Further, the speech recognition unit 11 detects the utterance zone in the speech data received from the speech input unit 2 and implements the recognition processing within a preset period. The “preset period” includes, for example, a period in which the in-vehicle equipment 1 is activated, a period ranging from a time at which the speech recognition device 10 is activated or reactivated to a time at which the speech recognition device 10 is deactivated or stopped, a period in which the speech recognition unit 11 is activated, and so on. In Embodiment 1, it is assumed that the speech recognition unit 11 implements the processing described above in the period ranging from the time at which the speech recognition device 10 is activated to the time at which the speech recognition device 10 is deactivated.

Note that in Embodiment 1, the recognition result output by the speech recognition unit 11 is described as a specific character string such as a command name, but as long as the commands can be differentiated, the output recognition result may take any form, such as an ID represented by numerals, for example. This applies similarly to following embodiments.

The determination unit 12 determines whether the number of utterers in the vehicle is singular or plural, and outputs its determination result to the recognition control unit 13, which is described below.

In Embodiment 1, “utterer” is also referred to as something which may cause the speech recognition device 10 and the in-vehicle equipment 1 to erroneously operate by voice, and babies, animals, and the like are included.

For example, the determination unit 12 obtains image data captured by the camera 3 disposed in the vehicle, and determines whether the number of passengers in the vehicle is singular or plural by analyzing the image data. Alternatively, the determination unit 12 may obtain pressure data relating to each seat, which are detected by the pressure sensor 4 disposed in each seat, and determine whether the number of passengers in the vehicle is singular or plural by determining whether or not a passenger is seated on each seat on the basis of the pressure data. The determination unit 12 determines the number of passengers to be the number of utterers.

Well-known technology may be used as the determination method described above, and therefore detailed description of the method will be omitted. Note that the determination method is not limited to the above method. Moreover, FIG. 1 shows a configuration in which both the camera 3 and the pressure sensor 4 are used, but a configuration in which only the camera 3 is used may be adopted, for example.

Furthermore, when the number of passengers in the vehicle is plural, but the number of possible utterers is singular, the determination unit 12 may determine that the number of utterers is singular.

For example, the determination unit 12 analyzes the image data obtained from the camera 3, determines whether the passengers are awake or asleep, and counts the number of passengers who are awake as the number of utterers. In contrast, it is unlikely that passengers who are asleep utter words, and accordingly the determination unit 12 does not count the passengers who are asleep in the number of utterers.

When the determination result received from the determination unit 12 is “plural”, the recognition control unit 13 instructs the speech recognition unit 11 to set the recognized vocabulary as “a combination of keyword and command”. In contrast, when the determination result is “singular”, the recognition control unit 13 instructs the speech recognition unit 11 to set the recognized vocabulary as both “a command” and “a combination of keyword and command”.

When the speech recognition unit 11 uses “a combination of keyword and command” as the recognized vocabulary, and uttered speech corresponds to the combination of keyword and command, recognition is successfully made, and in contrast, when other uttered speech does not correspond to the combination of keyword and command, recognition ends in failure. Further, when the speech recognition unit 11 uses “a command” as the recognized vocabulary, and uttered speech corresponds to only the command, recognition is successfully made, and in contrast, when other uttered speech does not correspond to the command, recognition ends in failure.

Hence, when there is only one utterer in the vehicle and the utterer utters either a command alone or a combination of keyword and command, the speech recognition device 10 recognizes the utterance successfully, whereupon the in-vehicle equipment 1 executes an operation corresponding to the command. Further, when there are a plurality of utterers in the vehicle and any of the utterers utters a combination of keyword and command, the speech recognition device 10 recognizes the utterance successfully, whereupon the in-vehicle equipment 1 executes an operation corresponding to the command, but when any of the utterers utters a command alone, the speech recognition device 10 fails to recognize the utterance, and the in-vehicle equipment 1 does not execute an operation corresponding to the command.

Note that in the following description, it is assumed that the recognition control unit 13 instructs the speech recognition unit 11 to set the recognized vocabulary in the manner described above, but instead, when the determination result received from the determination unit 12 is “singular”, the recognition control unit 13 may instruct the speech recognition unit 11 to recognize at least “a command”.

Instead of configuring the speech recognition unit 11 as described above, i.e., such that when the determination result is “singular”, “a command” and “a combination of keyword and command” are used as the recognized vocabulary, whereby at least “a command” can be recognized, the speech recognition unit 11 may be configured using well-known technology such as word spotting, for example, such that from an utterance including “a command”, the “command” alone is output as the recognition result.

In a case where the determination result received from the determination unit 12 is “plural”, the recognition control unit 13, upon reception of the recognition result from the speech recognition unit 11, adopts the recognition result relating to the speech uttered after the “keyword” indicating that a command is about to be uttered. In contrast, in a case where the determination result received from the determination unit 12 is “singular”, the recognition control unit 13, upon reception of the recognition result from the speech recognition unit 11, adopts the recognition result relating to the uttered speech regardless of the presence or absence of the “keyword” indicating that a command is about to be uttered. Here, “adopt” means determining that a certain recognition result is to be output to the control unit 14 as “a command”.

More specifically, when the recognition result received from the speech recognition unit 11 includes the “keyword”, the recognition control unit 13 deletes the part corresponding to the “keyword” from the recognition result, and outputs the part corresponding to the “command” uttered after the “keyword” to the control unit 14. In contrast, when the recognition result does not include the “keyword”, the recognition control unit 13 outputs the recognition result corresponding to the “command” as it is, to the control unit 14.

The control unit 14 performs an operation corresponding to the recognition result received from the recognition control unit 13, and outputs a result of the operation on the display unit 5 or through the speaker 6. When, for example, the recognition result received from the recognition control unit 13 is “Search for a convenience store”, the control unit 14 searches for a convenience store on the periphery of a host vehicle position using map data, displays a search result on the display unit 5, and outputs guidance indicating that a convenience store has been found through the speaker 6. It is assumed that a correspondence relationship between the “command” serving as the recognition result and the operation is set in advance in the control unit 14.

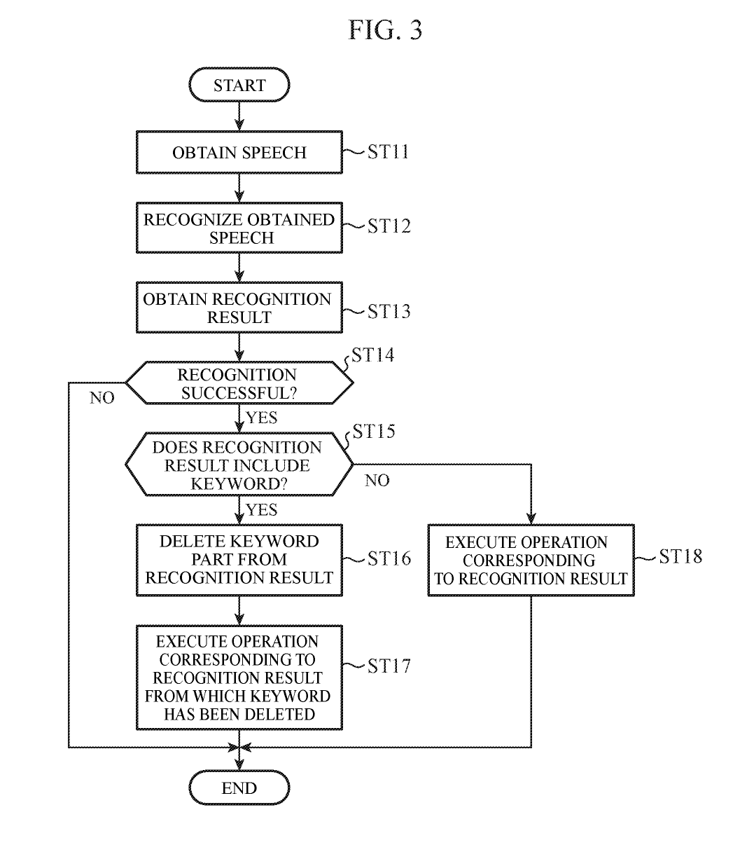

Next, an operation of the in-vehicle equipment 1 according to Embodiment 1 will be described using flowcharts shown in FIGS. 2 and 3 and specific examples. Note that in the following description, “Mitsubishi” is set as the “keyword”, but the “keyword” is not limited thereto. Further, it is assumed that the in-vehicle equipment 1 executes the processing of the flowcharts shown in FIGS. 2 and 3 repeatedly while the speech recognition device 10 is activated.

FIG. 2 shows a flowchart implemented to switch the recognized vocabulary in the speech recognition unit 11 in accordance with whether the number of utterers in the vehicle is singular or plural.

First, the determination unit 12 determines the number of utterers in the vehicle on the basis of information obtained from the camera 3 or the pressure sensors 4 (step ST01), and then outputs the determination result to the recognition control unit 13 (step ST02).

Next, when the determination result received from the determination unit 12 is “singular” (“YES” in step ST03), the recognition control unit 13 instructs the speech recognition unit 11 to set “a command” and “a combination of keyword and command” as the recognized vocabulary to ensure that the in-vehicle equipment 1 can be operated regardless of whether or not the specific indication is received from the utterer (step ST04). In contrast, when the determination result received from the determination unit 12 is “plural” (“NO” in step ST03), the recognition control unit 13 instructs the speech recognition unit 11 to set “a combination of keyword and command” as the recognized vocabulary to ensure that the in-vehicle equipment 1 can be operated only when the specific indication is received from the utterer (step ST05).

FIG. 3 shows a flowchart implemented to recognize speech uttered by the utterer and perform an operation corresponding to the recognition result.

First, the speech recognition unit 11 receives speech data generated when speech uttered by the utterer is received by the speech input unit 2 and subjected to A/D conversion (step ST11). Next, the speech recognition unit 11 implements recognition processing on the speech data received from the speech input unit 2, and outputs the recognition result to the recognition control unit 13 (step ST12). When recognition is successfully made, the speech recognition unit 11 outputs the recognized character string or the like as the recognition result. When recognition fails, the speech recognition unit 11 outputs a message indicating failure as the recognition result.

Next, the recognition control unit 13 receives the recognition result from the speech recognition unit 11 (step ST13). The recognition control unit 13 then determines whether or not speech recognition has been successfully made on the basis of the recognition result, and when determining that speech recognition by the speech recognition unit 11 has not been successfully made (“NO” in step ST14), the recognition control unit 13 does nothing.

It is assumed, for example, that a plurality of utterers are present in the vehicle, and “Mr. A, Search for a convenience store” is uttered. In this case, during the processing of FIG. 2, the number of utterers in the vehicle is determined to be plural, and since the recognized vocabulary used by the speech recognition unit 11 is set at “a combination of keyword and command”, such as “Mitsubishi, Search for a convenience store”, for example, speech recognition by the speech recognition unit 11 is not successfully made. Thus, the recognition control unit 13 determines “unsuccessful recognition” on the basis of the recognition result received from the speech recognition unit 11 (“NO” in step ST11 to step ST14), and as a result, the in-vehicle equipment 1 does not perform any operation.

Further, for example, when it is obvious from the development of dialog heretofore that the addressee of the utterer is Mr. A, and the utterer says “Search for a convenience store” without mentioning “Mr. A”, speech recognition by the speech recognition unit 11 is also not successfully made. Thus, the in-vehicle equipment 1 does not perform any operation.

In contrast, when determining on the basis of the recognition result received from the speech recognition unit 11 that speech recognition by the speech recognition unit 11 has been successfully made (“YES” in step ST14), the recognition control unit 13 determines whether or not the recognition result includes the keyword (step ST15). When the recognition result includes the keyword (“YES” in step ST15), the recognition control unit 13 deletes the keyword from the recognition result, and then outputs the recognition result to the control unit 14 (step ST16).

Next, the control unit 14 receives the recognition result, from which the keyword has been deleted, from the recognition control unit 13, and performs an operation corresponding to the received recognition result (step ST17).

It is assumed, for example, that a plurality of utterers are present in the vehicle, and “Mitsubishi, Search for a convenience store” is uttered. In this case, during the processing of FIG. 2, the number of utterers in the vehicle is determined to be plural, and the recognized vocabulary used by the speech recognition unit 11 is set as “a combination of keyword and command”. Hence, the speech recognition unit 11 successfully recognizes the above utterance including the keyword, and the recognition control unit 13 determines “successful recognition” on the basis of the recognition result received from the speech recognition unit 11 (“YES” in step ST11 to step ST14).

The recognition control unit 13 then outputs “Search for a convenience store”, which is obtained by deleting “Mitsubishi”, which is “keyword”, from the received recognition result, namely “Mitsubishi, Search for a convenience store”, to the control unit 14 as a command (“YES” in step ST15, step ST16). The control unit 14 then searches for a convenience store on the periphery of the host vehicle position using the map data, displays the search result on the display unit 5, and outputs guidance indicating that a convenience store has been found through the speaker 6 (step ST17).

In contrast, when the recognition result does not include the keyword (“NO” in step ST15), the recognition control unit 13 outputs the recognition result as it is, to the control unit 14 as a command. The control unit 14 then performs an operation corresponding to the recognition result received from the recognition control unit 13 (step ST18).

It is assumed, for example, that there is only one utterer in the vehicle, and “Search for a convenience store” is uttered. In this case, during the processing of FIG. 2, the number of utterers in the vehicle is determined to be singular, and the recognized vocabulary used by the speech recognition unit 11 is set as both “a command” and “a combination of keyword and command”. Hence, the recognition processing by the speech recognition unit 11 is successfully made, and thus the recognition control unit 13 determines “successful recognition” on the basis of the recognition result received from the speech recognition unit 11 (“YES” in step ST11 to step ST14). The recognition control unit 13 then outputs the received recognition result, namely “Search for a convenience store”, to the control unit 14. The control unit 14 then searches for a convenience store on the periphery of the host vehicle position using the map data, displays the search result on the display unit 5, and outputs guidance indicating that a convenience store has been found through the speaker 6 (step ST17).

Further, it is assumed, for example, that there is only one utterer in the vehicle, and “Mitsubishi, Search for a convenience store” is uttered. In this case, during the processing of FIG. 2, the number of utterers in the vehicle is determined to be singular, and since the recognized vocabulary used by the speech recognition unit 11 is set as both “a command” and “a combination of keyword and command”, the recognition processing by the speech recognition unit 11 is successfully made. Accordingly, the recognition control unit 13 determines “successful recognition” on the basis of the recognition result received from the speech recognition unit 11 (“YES” in step ST11 to step ST14). In this case, the recognition result includes the keyword in addition to a command, and thus the recognition control unit 13 deletes the unnecessary “Mitsubishi” from the received recognition result, namely “Mitsubishi, Search for a convenience store”, and outputs “Search for a convenience store” to the control unit 14.

According to Embodiment 1, as described above, the speech recognition device 10 is configured to include the speech recognition unit 11 for recognizing speech and outputting the recognition result, the determination unit 12 for determining whether the number of utterers in the vehicle is singular or plural, and outputting the determination result, and the recognition control unit 13 which, on the basis of the results output by the speech recognition unit 11 and the determination unit 12, adopts the recognition result relating to the speech uttered after the indication that an utterance is about to start is received when the number of utterers is determined to be plural, and when the number of utterers is determined to be singular, adopts a recognition result regardless of whether the recognition result relates to the speech uttered after the indication that an utterance is about to start is received, or the recognition result relates to the speech uttered in a case where the indication that an utterance is about to start is not received. Therefore, a situation in which an utterance given by a certain utterer to another utterer is recognized erroneously as a command when a plurality of utterers are present in the vehicle can be avoided. Moreover, when only one utterer is present in the vehicle, the utterer does not need to utter a specific utterance before uttering a command, and therefore awkward and troublesome dialog can be eliminated, enabling an improvement in operability. As a result, a natural dialog similar to a dialog between people can be achieved.

Further, according to the Embodiment 1, the in-vehicle equipment 1 is configured to include the speech recognition device 10, and the control unit 14 for performing an operation corresponding to the recognition result adopted by the speech recognition device 10, and therefore a situation in which an operation is performed erroneously in response to an utterance given by a certain utterer to another utterer when a plurality of utterers are present in the vehicle can be avoided. Moreover, when only one utterer is present in the vehicle, the utterer does not need to utter a specific utterance before uttering a command, and therefore awkward and troublesome dialog can be eliminated, enabling an improvement in operability.

Furthermore, according to Embodiment 1, the determination unit 12 determines that the number of utterers is singular when the number of passengers in the vehicle is plural but the number of possible utterers is singular, and therefore the driver can operate the in-vehicle equipment 1 without uttering a specific utterance in a situation where passengers other than the driver are asleep, for example.

### Embodiment 2

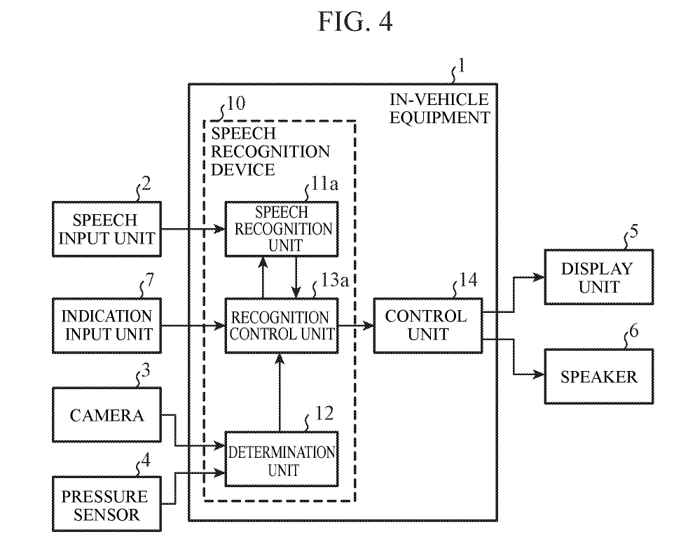

FIG. 4 is a block diagram showing an example configuration of the in-vehicle equipment 1 according to Embodiment 2 of the invention. Note that identical configurations to those described in Embodiment 1 have been allocated identical reference numerals, and duplicate description thereof will be omitted.

In Embodiment 2, the “specific indication” clarifying that the utterer is about to utter a command is set as “a manual operation indicating that a command is about to be uttered”. When the number of utterers in the vehicle is plural, the in-vehicle equipment 1 operates in response to content uttered after a manual operation indicating that the utterer is about to utter a command is performed. In contrast, when the number of utterers in the vehicle is singular, the in-vehicle equipment 1 operates in response to the content of an utterance given by the utterer regardless of whether or not the manual operation is performed.

An indication input unit 7 receives an indication that is input manually by the utterer. The indication is made, for example, with a switch on a piece of hardware, a touch sensor incorporated into a display, or a recognition device that recognizes an indication that is input by the utterer via a remote control.

The indication input unit 7, upon reception of an input indication that a command is about to be uttered, outputs the indication that an utterance is about to start to a recognition control unit 13a.

In a case where the determination result received from the determination unit 12 is “plural”, the recognition control unit 13a, upon reception of the indication that a command is about to be uttered from the indication input unit 7, notifies a speech recognition unit 11a that a command is about to be uttered.

After having received the indication that a command is about to be uttered from the indication input unit 7, the recognition control unit 13a adopts the recognition result received from the speech recognition unit 11a, and outputs the recognition result to the control unit 14. In contrast, when the indication that a command is about to be uttered is not received from the indication input unit 7, the recognition control unit 13a discards the recognition result output by the speech recognition unit 11a rather than adopting the recognition result. In other words, the recognition control unit 13a does not output the recognition result to the control unit 14.

In a case where the determination result received from the determination unit 12 is “singular”, the recognition control unit 13a adopts the recognition result received from the speech recognition unit 11a and outputs the recognition result to the control unit 14 regardless of whether or not the indication that an utterance is about to start has been received from the indication input unit 7.

The speech recognition unit 11a uses “a command” as the recognized vocabulary regardless of whether the number of utterers in the vehicle is singular or plural, implements recognition processing upon reception of speech data from the speech input unit 2, and outputs the recognition result to the recognition control unit 13a. In a case where the determination result from the determination unit 12 is “plural”, the notification from the recognition control unit 13a indicates clearly that a command is about to be uttered, and therefore a recognition rate of the speech recognition unit 11a can be improved.

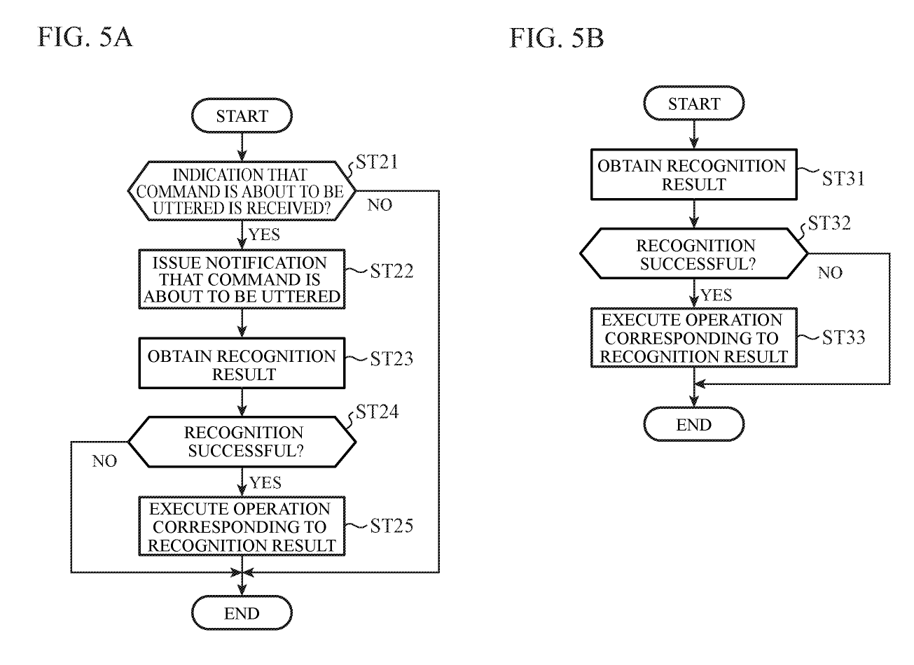

Next, an operation of the in-vehicle equipment 1 according to Embodiment 2 will be described using flowcharts shown in FIGS. 5A and 5B. Note that in Embodiment 2, it is assumed that the determination unit 12 determines whether or not the number of utterers in the vehicle is plural and outputs the determination result to the recognition control unit 13a while the speech recognition device 10 is activated. Further, it is assumed that while the speech recognition device 10 is activated, the speech recognition unit 11a implements recognition processing on the speech data received from the speech input unit 2 and outputs the recognition result to the recognition control unit 13a regardless of the presence or absence of the above indication that a command is about to be uttered.

FIG. 5A is a flowchart showing processing performed in a case where the determination unit 12 determines that the number of utterers in the vehicle is plural. It is assumed that the in-vehicle equipment 1 repeatedly executes the processing of the flowchart shown in FIG. 5A while the speech recognition device 10 is activated.

First, the recognition control unit 13a, after receiving the indication that a command is about to be uttered from the indication input unit 7 (“YES” in step ST21), notifies the speech recognition unit 11a that a command is about to be uttered (step ST22). Next, the recognition control unit 13a receives the recognition result from the speech recognition unit 11a (step ST23), and determines whether or not speech recognition has been successfully made on the basis of the recognition result (step ST24).

After determining “successful recognition” (“YES” in step ST24), the recognition control unit 13a outputs the recognition result to the control unit 14. The control unit 14 then executes an operation corresponding to the recognition result received from the recognition control unit 13a (step ST25). In contrast, after determining “unsuccessful recognition” (“NO” in step ST24), the recognition control unit 13a does nothing.

When the indication that a command is about to be uttered is not received from the indication input unit 7 (“NO” in step ST21), the recognition control unit 13a discards the recognition result, even when receiving the recognition result from the speech recognition unit 11a. In other words, even when the speech recognition device 10 recognizes the speech uttered by the utterer, the in-vehicle equipment 1 does not perform any operation.

FIG. 5B is a flowchart showing processing performed in a case where the determination unit 12 determines that the number of utterers in the vehicle is singular. It is assumed that the in-vehicle equipment 1 repeatedly executes the processing of the flowchart shown in FIG. 5B while the speech recognition device 10 is activated.

First, the recognition control unit 13a receives the recognition result from the speech recognition unit 11a (step ST31). Next, the recognition control unit 13a determines whether or not speech recognition has been successfully made on the basis of the recognition result (step ST32), and when determining “successful recognition”, outputs the recognition result to the control unit 14 (“YES” in step ST32). The control unit 14 then executes an operation corresponding to the recognition result received from the recognition control unit 13a (step ST33).

In contrast, after determining “unsuccessful recognition” (“NO” in step ST32), the recognition control unit 13a does nothing.

According to Embodiment 2, as described above, the speech recognition device 10 is configured to include the speech recognition unit 11a for recognizing speech and outputting the recognition result, the determination unit 12 for determining whether the number of utterers in the vehicle is singular or plural, and outputting the determination result, and the recognition control unit 13a which, on the basis of the results output by the speech recognition unit 11a and the determination unit 12, adopts the recognition result relating to the speech uttered after the indication that an utterance is about to start is received when the number of utterers is determined to be plural, and when the number of utterers is determined to be singular, adopts a recognition result regardless of whether the recognition result relates to the speech uttered after the indication that an utterance is about to start is received, or the recognition result relates to the speech uttered in a case where the indication that an utterance is about to start is not received. Therefore, a situation in which an utterance given by a certain utterer to another utterer is recognized erroneously as a command when a plurality of utterers are present in the vehicle can be avoided. Moreover, when only one utterer is present in the vehicle, the utterer does not need to perform a specific operation before uttering a command, and therefore awkward and troublesome utterances can be eliminated, enabling an improvement in operability. As a result, a natural dialog resembling a dialog between people can be achieved.

Further, according to Embodiment 2, the in-vehicle equipment 1 is configured to include the speech recognition device 10, and the control unit 14 for performing an operation corresponding to the recognition result adopted by the speech recognition device 10, and therefore a situation in which an operation is performed erroneously in response to an utterance given by a certain utterer to another utterer when a plurality of utterers are present in the vehicle can be avoided. Moreover, when only one utterer is present in the vehicle, the utterer does not need to perform a specific operation before uttering a command, and therefore awkward and troublesome dialog can be eliminated, enabling an improvement in operability.

Furthermore, according to Embodiment 2, similarly to Embodiment 1 described above, the determination unit 12 can determine that the number of utterers is singular when the number of passengers in the vehicle is plural but the number of possible utterers is singular, and therefore the driver can operate the in-vehicle equipment 1 without performing a specific operation in a situation where passengers other than the driver are asleep, for example.

Next, a modified example of the speech recognition device 10 will be described.

In the speech recognition device 10 shown in FIG. 1, the speech recognition unit 11 recognizes uttered speech using “a command” and “a combination of keyword and command” as recognized vocabulary, regardless of whether the number of utterers in the vehicle is singular or plural. The speech recognition unit 11 outputs the “command” alone as the recognition result, or outputs both the “keyword” and the “command” as the recognition result, or outputs a message indicating unsuccessful recognition as the recognition result.

In a case where the determination result received from the determination unit 12 is “plural”, the recognition control unit 13, upon reception of the recognition result from the speech recognition unit 11, adopts the recognition result relating to the speech uttered after the “keyword”.

In other words, when the recognition result received from the speech recognition unit 11 includes both the “keyword” and “a command”, the recognition control unit 13 deletes the part corresponding to the “keyword” from the recognition result, and outputs the part corresponding to the “command” uttered after the “keyword” to the control unit 14. In contrast, when the recognition result received from the speech recognition unit 11 does not include the “keyword”, the recognition control unit 13 discards the recognition result without adopting the recognition result, and does not output the recognition result to the control unit 14.

Further, when recognition by the speech recognition unit 11 is unsuccessful, the recognition control unit 13 does nothing.

In a case where the determination result received from the determination unit 12 is “singular”, the recognition control unit 13, upon reception of the recognition result from the speech recognition unit 11, adopts the recognition result relating to the uttered speech regardless of the presence or absence of the “keyword”.

In other words, when the recognition result received from the speech recognition unit 11 includes both the “keyword” and “a command”, the recognition control unit 13 deletes the part corresponding to the “keyword” from the recognition result, and outputs the part corresponding to the “command” uttered after the “keyword” to the control unit 14. In contrast, when the recognition result received from the speech recognition unit 11 does not include the “keyword”, the recognition control unit 13 outputs the recognition result corresponding to the “command” as it is to the control unit 14.

Further, when recognition by the speech recognition unit 11 is unsuccessful, the recognition control unit 13 does nothing.

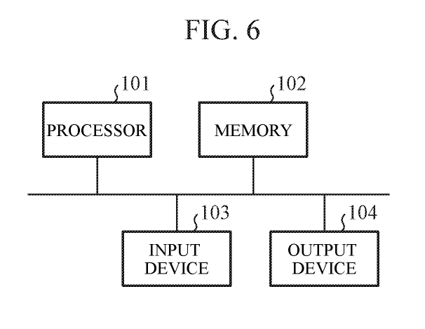

Next, an example configuration of main hardware of the in-vehicle equipment 1 according to Embodiments 1 and 2 of the invention and peripheral equipment thereof will be described. FIG. 6 is a view showing a configuration of the main hardware of the in-vehicle equipment 1 according to the respective embodiments of the invention and the peripheral equipment thereof.

Respective functions of the speech recognition units 11, 11a, the determination unit 12, the recognition control units 13, 13a, and the control unit 14 provided in the in-vehicle equipment 1 are achieved by a processing circuit. More specifically, the in-vehicle equipment 1 includes a processing circuit for determining whether the number of utterers in the vehicle is singular or plural, adopting the recognition result relating to the speech uttered after receiving the indication that an utterance is about to start when the number of utterers is determined to be plural, adopting the recognition result relating to the uttered speech regardless of whether or not the indication that an utterance is about to start is received when the number of utterers is determined to be singular, and performing an operation corresponding to the adopted recognition result. The processing circuit is a processor 101 that executes a program stored in a memory 102. The processor 101 is a CPU (Central Processing Unit), a processing device, a calculation device, a microprocessor, a microcomputer, a DSP (Digital Signal Processor), or the like. Note that the respective functions of the in-vehicle equipment 1 may be achieved using a plurality of processors 101.

The respective functions of the speech recognition units 11, 11a, the determination unit 12, the recognition control units 13, 13a, and the control unit 14 are achieved by software, firmware, or a combination of software and firmware. The software or firmware is described in the form of programs and stored in the memory 102. The processor 101 achieves the functions of the respective units by reading and executing the programs stored in the memory 102. More specifically, the in-vehicle equipment 1 includes the memory 102 which for storing the programs which, when executed by the processor 101, allows the steps shown in FIGS. 2 and 3 or the steps shown in FIG. 5 to be resultantly executed. The programs may also be said to cause a computer to execute procedures or methods of the speech recognition units 11, 11a, the determination unit 12, the recognition control units 13, 13a, and the control unit 14. The memory 102 may be, for example, a non-volatile or a volatile semiconductor memory such as a RAM (Random Access Memory), a ROM (Read Only Memory), a flash memory, an EPROM (Erasable Programmable ROM), or an EEPROM (Electrically EPROM), a magnetic disc such as a hard disc or a flexible disc, or an optical disc such as a minidisc, a CD (Compact Disc), or a DVD (Digital Versatile Disc).

An input device 103 serves as the speech input unit 2, the camera 3, the pressure sensor 4, and the indication input unit 7. An output device 104 serves as the display unit 5 and the speaker 6.

Note that within the scope of the invention, the respective embodiments of the invention may be freely combined, and any of constituent elements of each embodiment may be modified or omitted.

### INDUSTRIAL APPLICABILITY

The speech recognition device according to the invention adopts the recognition result relating to the speech uttered after receiving the indication that an utterance is about to start when the number of utterers is plural, and adopts the recognition result relating to the uttered speech regardless of whether or not the indication is received when the number of utterers is singular, and is therefore suitable for use as an in-vehicle speech recognition device or the like that recognizes utterances uttered by utterers at all times.

### REFERENCE SIGNS LIST

1 In-vehicle equipment

2 Speech input unit

3 Camera

4 Pressure sensor

5 Display unit

6 Speaker

7 Indication input unit

10 Speech recognition device

11, 11a Speech recognition unit

12 Determination unit

13, 13a Recognition control unit

14 Control unit

101 Processor

102 Memory

103 Input device

104 Output device

1. An in-vehicle speech recognition device comprising:
a speech recognition unit to recognize speech and output a recognition result;
a determiner to determine whether the number of utterers in a vehicle is singular or plural, and output a determination result; and
a recognition controller, on a basis of the results output by the speech recognition unit and the determiner, to adopt a recognition result relating to speech uttered after an indication that an utterance is about to start is received when the number of utterers is determined to be plural, and when the number of utterers is determined to be singular, to adopt a recognition result regardless of whether the recognition result relates to speech uttered after an indication that an utterance is about to start is received, or the recognition result relates to speech uttered in a case where the indication that an utterance is about to start is not received.

2. The in-vehicle speech recognition device according to claim 1, wherein the determiner determines that the number of utterers is singular when the number of passengers in the vehicle is plural but the number of possible utterers is singular.

3. The in-vehicle speech recognition device according to claim 2, wherein the determiner determines whether the passengers in the vehicle are awake or asleep, and counts passengers who are awake as the possible utterers.

4. In-vehicle equipment comprising:
a speech recognition unit to recognize speech and output a recognition result;
a determiner to determine whether the number of utterers in a vehicle is singular or plural, and output a determination result;
a recognition controller, on a basis of the results output by the speech recognition unit and the determiner, to adopt a recognition result relating to speech uttered after an indication that an utterance is about to start is received when the number of utterers is determined to be plural, and when the number of utterers is determined to be singular, to adopt a recognition result regardless of whether the recognition result relates to speech uttered after the indication that an utterance is about to start is received, or the recognition result relates to speech uttered in a case where the indication that an utterance is about to start is not received; and
a controller to perform an operation corresponding to the recognition result adopted by the recognition controller.
